(19) United States
(12) Patent Application Publication
(10) Pub. No.: US 2003/0108799 A1
(43) Pub. Date: Jun. 12, 2003

(54) All-solid-type polymer electrolyte electrochemical generator comprising fluorinated polymers

(76) Inventors: Stephane Lascaud, Fontainebleau (FR); Marc Deschamps, Quimper (FR)

Correspondence Address: D Douglas Price, Steptoe & Johnson, 1330 Connecticut Avenue N W, Washington, DC, 20036, US

(21) Appl. No.: 10/030,359

(22) PCT Filed: May 4, 2001
(86) PCT No.: PCT/FR01/01379

(30) Foreign Application Priority Data
May 4, 2000 (FR) 00/05701

(51) Int. Cl. H01M 10/40; H01M 4/58

(52) U.S. Cl. 429/316; 429/317; 429/307; 429/231.95; 429/231.8

(57) ABSTRACT

The invention concerns an all-solid-state electrochemical generator (1) comprising a negative electrode (4) capable of supplying a lithium cation, an all-solid-state polymer electrolyte (3) formed with a macromolecular material wherein ionised lithium salt is dissolved and a second positive electrode capable of incorporating a non-ionised species corresponding to said lithium cation. The invention is characterised in that the all-solid-state polymer electrolyte comprises one or several fluorinated polymer(s) and the mass ratio macromolecular material/fluorinated polymer(s) ranges between 6 and 700.

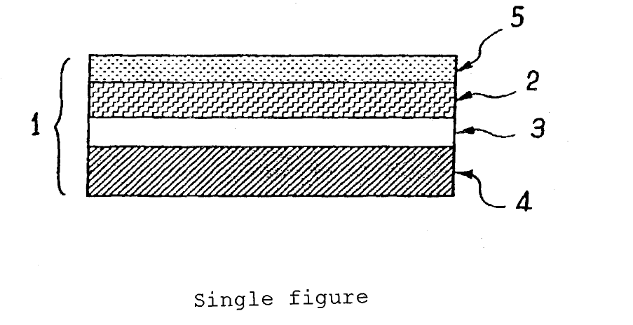

The invention relates to the field of rechargeable lithium storage batteries or all-solid-state electrochemical generators, of the type comprising at least one negative electrode capable of delivering a lithium cation, an all-solid-state alkaline polymeric electrolyte and a positive electrode capable of incorporating the nonionized species corresponding to said lithium cation.

The invention also relates to the all-solid-state polymeric electrolytes useful, in particular, for producing the electrochemical generators according to the invention.

The operation of a lithium storage battery involves the transfer by ionic conduction, via a plastic or liquid electrolyte, of lithium cations coming from the negative electrode or “source” to the positive electrode or “well” in the case of the nonionized species corresponding to the lithium cation.

In the case of rechargeable storage batteries called secondary storage batteries, it is known that these have to have an almost constant specific energy during the many charge/discharge cycles.

In practice, a storage battery must be able to undergo more than 500 charge/discharge cycles without the delivered energy being significantly reduced.

A problem likely to affect the constancy of the energy delivered during charge/discharge cycles lies in the imperfect deposition of lithium on the lithium negative electrode. It has in fact been found that in lithium storage batteries the deposition of lithium during recharging occurs nonuniformly, in the form of tree structures or dendrites, which gives rise to local short circuits. It is acknowledged that this phenomenon occurs more rapidly the higher the current density. This phenomenon limits the lifetime, that is to say the number of charge/discharge cycles, of storage batteries.

The use of a polymeric electrolyte partly overcomes this problem.

Two technologies are used at the present time:

all-solid-state or “dry” technology;

plasticized or gelled technology.

The addition of a plasticizer is justified by the substantial improvement in the ionic conductivity of the electrolytic membrane. Operation at room temperature, or even lower, becomes possible. This is far from being the case with all-solid-state technology.

The addition of a plasticizer requires the incorporation of another polymer. This is because the mechanical strength of polyethers (frequently used in both these technologies) is too low to allow use as a separator when a plasticizer is incorporated into them. This polymer is in general a fluoropolymer. A ratio of 1 between the polyether and the fluoropolymer is a good compromise between conductivity and mechanical strength (see U.S. Pat. No. 6,185,645). The incorporation of too large an amount of fluoropolymer will have deleterious consequences on the conductivity, since a fluoropolymer is much inferior in terms of ionic conductivity to polyethers.

In the case of all-solid-state technology, the mechanical strength is provided by the polyether itself. Its mechanical strength is sufficient and does not require the incorporation of another polymer. The incorporation of a fluoropolymer even becomes deleterious from the standpoint of ionic conductivity.

In general, such lithium storage batteries result from the lamination/assembly of three thin films (three-layer assembly): a film of positive electrode containing an electrochemically active material, a film of alkaline polymeric electrolyte, especially a polyether, and of a lithium salt, and a film of a lithium-based negative electrode.

The storage battery is connected up by a collector associated with the positive electrode, the negative electrode itself acting as collector.

The thickness of such a storage battery is around 30 to 300 μm, each of the electrode films having a thickness of 10 to 100 μm. It should be noted that, the polymeric electrolyte essentially acting as a cation transporter, its thickness may be thin, especially much thinner than the electrodes with which it is associated.

To further limit the formation of dendrites, it has been proposed to modify the surface of the lithium anode by hydrofluoric acid (Takehara: 8th International Congress, Nagoya 1996). This treatment of the lithium anode substantially improves the performance of the cells—fluorine modifies the oxidized surface layer of the lithium, thereby reducing the reactivity of the lithium with respect to the electrolyte.

It has also been proposed to incorporate CO₂ (Z. Takehara et al., J. Power Sources, 43/44, 377 (1993)).

It is by a completely different route that the inventors have solved the abovementioned problem.

It is one of the objects of the present invention to propose novel all-solid-state polymeric electrolytes making it possible to ensure very many charge/discharge cycles at a virtually constant specific energy, in particular by reducing the tree-forming phenomenon during lithium redeposition on the negative lithium electrode.

Moreover, these novel all-solid-state polymeric electrolytes are easy to manufacture and possess excellent mechanical properties.

The invention is based on the observation that adding, to the all-solid-state polymeric electrolytes, in addition to the possible usual fillers, small amounts of fluoropolymers allows the desired results mentioned above to be achieved.

The invention therefore relates in the first place to an all-solid-state electrochemical generator comprising a negative electrode capable of delivering a lithium cation, an all-solid-state polymeric electrolyte formed from a macromolecular material in which an ionized lithium salt is dissolved and a positive electrode capable of incorporating the nonionized species corresponding to said lithium cation, characterized in that the all-solid-state polymeric electrolyte comprises at least one (where appropriate, several) fluoropolymer(s) in a macromolecular material/fluoropolymer(s) mass ratio of between 6 and 700.

In the current state of analysis of the experimentally observed phenomenon, it seems that fluorocompounds react according to an acid-base reaction by the substitution of the oxygen-containing species (oxide, hydroxide, carbonate) and/or of the nitrogen with fluorine. The fluorocompounds react in particular, according to this hypothesis, with lithium hydroxide and/or lithium oxide.

The fluoropolymers may vary very widely in nature, but mention may be made in particular of PVDF, PHFP, PCTFE, PTFE, PVF₂, PVF, etc.

Of course, one or more fluoropolymers may be used.

Preferably, the alkaline polymeric electrolyte comprises approximately 0.1 to 10 wt % of fluoropolymers, preferably 0.5 to 5 wt %.

This value range is low enough not to excessively degrade the ionic conductivity and not high enough to significantly modify the mechanical strength. The polyether/fluoropolymer mass ratio is markedly higher than that used in the gelled technology since it is at minimum equal to 6.

In the case of the negative electrode, it is possible to use any compound capable of liberating a lithium ion, at its interface with the polymeric electrolyte, preferably a lithium electrode. It is also possible to envision the use of a composite electrode and to provide a collector.

The positive electrode according to a preferred embodiment may consist of a composite material, by preference substantially homogeneous, of the active substance, of a compound inert to electronic conduction favoring the transfer of electrical charges into the collector, such as graphite (or acetylene black), and of the polymeric electrolyte.

With regard to the positive electrode, it will be possible to use any hybrid compound or intercalated compound comprising compounds or salts of an alkaline transition metal possessing a high electron activity with regard to alkali metals and capable of imposing on them, when they are in the ionized state, a low chemical potential with respect to that which they have when they are in the metallic state.

According to an advantageous variant, the positive electrode is a composite electrode comprising carbon, an active substance based on a transition metal, and a matrix of a polymeric electrolyte.

Among active substances, mention may advantageously be made of vanadium oxide, manganese oxide, nickel oxide, cobalt oxide and a mixture of these active substances.

The all-solid-state polymeric electrolytes consist of an ionically conducting macromolecular material at least partly formed by a polymeric solution of a lithiated ionic compound entirely dissolved within the plastic polymeric macromolecular material. Such materials are described, for example, in European patent No. 13 199. Copolymers derived from ethylene oxide are the macromolecular materials most often used and have already been described in many documents.

The thickness of the all-solid-state polymeric electrolyte is generally between 2 and 100 μm and preferably between 5 and 30 μm.

In general, many documents refer to the preparation of the principal constituents of these assemblies.

Document FR-A-2 616 971 describes, for example, the preparation of a lithium or lithiated alloy electrode by lamination, while documents EP-A-0 285 476 and EP-A-0 357 859 describe the preparation of such an electrode by melt deposition.

Documents FR-A-2 442 512, FR-A-2 523 769, FR-A-2 542 322, FR-A-2 557 735, FR-A-2 606 216 and U.S. Pat. No. 4,6290,944 describe various formulations of the electrolyte.

Document FR-A-2 563 382 describes various material formulations of the positive electrode based on V₂O₅ and on metallic sulfide and oxide.

Preferably, the positive electrode will have a thickness of between 10 and 150 μm and a proportion of active substance of between 20 and 80 wt %.

More specifically, the positive electrode will very preferably have a thickness of between 10 and 100 μm, very advantageously between 20 and 100 μm, and a proportion of active substance of between 25 and 65 wt %, very advantageously between 30 and 65%, or even between 45 and 65%.

To control the tree-forming phenomenon even more effectively, it has been found, unexpectedly, that it is advantageous for an antioxidant compound to be present in the polymeric electrolyte.

Although this amount of antioxidant may vary within appreciable proportions depending on the nature of the polymer used, it will be advantageous to use a proportion of antioxidant compound of between 0.5 and 3% with respect to the mass of polymer. It is obvious that this antioxidant must be compatible with said polymer.

Among antioxidants suitable within the context of the present invention, mention may be made of CHIMASSORB® 119, sold by Ciba-Geigy. Mention may also be made of quinone or hydroquinone derivatives and phenolic antioxidants.

Advantageously, the all-solid-state polymeric electrolyte includes a significant proportion of magnesia, between 5 and 30 wt %, preferably between 8 and 25 wt %. The invention also relates to novel all-solid-state polymer electrolytes useful, in particular, for producing electrochemical generators according to the invention, these consisting of a macromolecular material in which an ionized lithium salt is dissolved, characterized in that the polymeric electrolyte comprises at least one fluoropolymer and the macromolecular material/fluoropolymer(s) mass ratio is between 6 and 700.

The above description pertaining to the electrochemical generator and relating to the macromolecular material, the ionic compound and the fluoropolymers apply to the polymeric electrolyte according to the invention.

The polymer is preferably a polyether chosen from the group consisting of polymers resulting from the polymerization of ethylene oxide, propylene oxide or other oxyalkylenes.

The polymer, the ionic compound, the fluoropolymer(s) and, optionally, the magnesia are mixed in a known manner according to the techniques commonly used in the polymer field. The electrolyte film is obtained by extrusion or coextrusion with the electrode and collector films, or by coating.

Apart from arresting the propagation of dendrites during the first recharge, it has been found that this effect continues over a long period.

Further features, objectives and advantages of the present invention will become apparent on reading the examples which follow, and with regard to the appended drawing given by way of nonlimiting example.

### EXAMPLE 1

The single FIGURE is a schematic sectional view of an electrochemical generator.

The single FIGURE shows the battery 1 consisting of a positive electrode 2, an electrolyte 3 and a lithium negative electrode 4, these three elements being produced according to the invention, and a collector 5 associated with the positive electrode, the lithium negative electrode 4 acting as collector.

The positive electrode is a composite electrode comprising a mixture of vanadium oxide, electrolyte and acetylene black, with an acetylene black content of 12 vol %.

The electrolyte consists of 69.7% of polyethylene oxide of 300,000 molecular mass, in which lithium trifluoro-sulfonylimide, in a proportion such that the oxygen/lithium atomic ratio is equal to about 20 (i.e. 17.6%), 9.8% of magnesium oxide, 0.7% of antioxidant (IRGANOX) and 2.2% of PVDF/HFP copolymer are dissolved.

The positive electrode has a capacity of about 1 mAh/cm² for a thickness of 60 μm.

The thickness of the negative electrode, the surface of which is very uniform, is 50 μm and the thickness of the electrolyte polymer is 50 μm.

Said electrochemical generator shows no significant variation in the specific energy after 300 charge/variation discharge cycles.

### EXAMPLE 2

In this example, a comparison is made between the performance of two generators. Battery 2 is identical to battery 1 mentioned in example 1. Battery 3 consists of a positive electrode and a negative electrode identical to that of battery 2. The electrolyte of battery 3 consists of 71.3% of polyethylene oxide of 300,000 molecular mass, in which lithium trifluoro-sulfonylimide, in a proportion such that the oxygen/lithium atomic ratio is equal to about 20 (i.e. 18%), 10% of magnesium oxide and 0.7% of antioxidant (IRGANOX) are dissolved. Its thickness is 50 μm.

The sole difference between these two generators is the presence of PVDF/HFP copolymer, which is found in the electrolyte of battery 2.

These two batteries are cycled with a controlled current density. The charge time is 10 hours and the discharge time is 5 hours. The current density is increased gradually until the maximum capacity of the battery is reached or until a short circuit due, to the formation of a dendrite occurs.

In the case of battery 3, a short circuit appears when the charge current density exceeds 0.1 mA/cm². In the case of battery 2, it is possible to apply a charge current of 0.2 mA/cm² without causing a short circuit. The maximum capacity of the battery is then reached.

The use of the fluoropolymer therefore makes it possible to charge the battery at higher current densities.

1. An all-solid-state electrochemical generator (1) comprising a negative electrode (4) capable of delivering a lithium cation, an all-solid-state polymeric electrolyte (3) formed from a macromolecular material in which an ionized lithium salt is dissolved and a positive electrode capable of incorporating the nonionized species corresponding to said lithium cation, characterized in that the all-solid-state polymeric electrolyte comprises one or more fluoropolymers in a macromolecular material/fluoropolymers(s) mass ratio of between 6 and 700.

2. The all-solid-state electrochemical generator as claimed in claim 1, characterized in that the all-solid-state alkaline polymeric electrolyte comprises 0.1 to 10 wt % of fluoropolymer(s).

3. The all-solid-state electrochemical generator as claimed in claim 1, characterized in that the all-solid-state alkaline polymeric electrolyte comprises 0.5 to 5 wt % of fluoropolymer(s).

4. The all-solid-state electrochemical generator as claimed in one of claims 1 to 3, characterized in that the fluoropolymer is chosen from the group comprising the following polymers: PVDF, PHFP, PCTFE, PTFE, PVF₂, PVF.

5. The all-solid-state electrochemical generator as claimed in one of claims 1 to 4, characterized in that the positive electrode is made of a composite material, of the active substance, of a compound inert to electronic conduction favoring the transfer of electrical charges into a collector, such as graphite or acetylene black, and of the polymeric electrolyte.

6. The all-solid-state electrochemical generator as claimed in one of claims 1 to 5, characterized in that the positive electrode consists of a hybrid compound or intercalated compound comprising compounds or salts of an alkaline transition metal possessing a high electron activity with regard to alkali metals and capable of imposing on them, when they are in the ionized state, a low chemical potential with respect to that which they have when they are in the metallic state.

7. The all-solid-state electrochemical generator as claimed in one of claims 1 to 6, characterized in that the positive electrode is a composite electrode comprising carbon, an active substance based on a transition metal, and a matrix of a polymeric electrolyte.

8. The all-solid-state electrochemical generator as claimed in either of claims 5 and 7, characterized in that the active substance is chosen from the group consisting of vanadium oxide, manganese oxide, nickel oxide, cobalt oxide or a mixture of these active substances.

9. The all-solid-state electrochemical generator as claimed in claims 1 to 8, characterized in that the positive electrode has a thickness of between 10 and 150 μm and a proportion of active substance of between 20 and 80 wt %.

10. The all-solid-state electrochemical generator as claimed in one of claims 1 to 9, characterized in that the positive electrode has a thickness of between 10 and 100 μm and a proportion of active substance of between 25 and 65 wt %.

11. The all-solid-state electrochemical generator as claimed in one of claims 1 to 10, characterized in that the macromolecular material of the all-solid-state polymeric electrolyte is a polyether based on polyethylene oxide or polypropylene oxide, or polyoxyalkylenes.

12. The all-solid-state electrochemical generator as claimed in one of claims 1 to 11, characterized in that the negative electrode is a lithium electrode.

13. The all-solid-state electrochemical generator as claimed in one of claims 1 to 12, characterized in that the polymeric electrolyte comprises magnesia, preferably 5 to 30 wt %, very advantageously between 8 and 25 wt %.

14. The all-solid-state electrochemical generator as claimed in one of claims 1 to 13, characterized in that the macromolecular material of the all-solid-state polymeric electrolyte is formed by extrusion or by coextrusion with the electrode films.

15. The all-solid-state electrochemical generator as claimed in one of claims 1 to 14, characterized in that the polymeric electrolyte comprises an antioxidant compound.

16. The all-solid-state electrochemical generator as claimed in claim 15, characterized in that the proportion of antioxidant compound is between 0.5 and 3% with respect to the mass of polymer.

17. The all-solid-state electrochemical generator as claimed in either of claims 15 and 16, characterized in that the oxidant is chosen from the group comprising quinone or hydroquinone derivatives and phenolic antioxidants.

18. An all-solid-state polymeric electrolyte formed from a macromolecular material in which an ionized lithium salt is dissolved, and comprising one or more fluoropolymers, as defined in claims 1 to 17, which is useful, in particular, for producing all-solid-state electrochemical generators as claimed in one of claims 1 to 17, in which the macromolecular material/fluoropolymer(s) mass ratio is between 6 and 700.
